(19) United States
(12) Patent Application Publication
(10) Pub. No.: US 2018/0012233 A1
(43) Pub. Date: Jan. 11, 2018

(54) METHOD AND A SYSTEM FOR ALLOCATING EMISSIONS RESULTING FROM TRANSPORTATION OF CARGO

(71) Applicant: Flexport, Inc., San Francisco, CA (US)

(72) Inventor: Patrick Steigler, San Francisco, CA (US)

(21) Appl. No.: 15/643,284

(22) Filed: Jul. 6, 2017

Related U.S. Application Data
(60) Provisional application No. 62/359,190, filed on Jul. 6, 2016.

(51) Int. Cl. G06Q 30/00; G06Q 50/28; G06Q 30/04

(52) U.S. Cl. CPC G06Q 30/018; G06Q 30/04; G06Q 50/28

(57) ABSTRACT

Disclosed is a method and a system for allocating energistic loss and/or emissions resulting from transportation of cargo comprising determining shipment emissions and disaggregating the shipment emissions to provide the emissions resulting from each shipped product.

### CROSS REFERENCE TO OTHER RELATED APPLICATIONS

This application claims priority to U.S. Provisional Application Ser. No. 62/359,190 filed on Jul. 6, 2016, which is hereby incorporated in its entirety.

### TECHNICAL FIELD

The present invention generally relates to a method and a system for allocating energetic loss and/or emissions resulting from transportation of cargo. In particular, this disclosure relates to a method and a system for allocating emissions resulting from transportation of cargo based upon various factors such as distance, emission factor(s), and aggregate emission driver(s).

### BACKGROUND

Greenhouse gases (GHG) comprise a variety of manmade air pollutants, such as carbon dioxide, chlorofluorocarbons, methane, nitrogen oxides, etc. GHG act like a greenhouse trapping energy emitted from the ground making the planet warmer. Reducing greenhouse gases has become a topic of concern in recent years to avoid changing the climate of the Earth due to trapped energy from incoming solar radiation.

Many customers are now requesting reports on the carbon footprint of their shipments, which they may use as gauges for purchasing carbon credits and for monitoring their environmental impact. Currently, transportation companies calculate the carbon dioxide emissions of shipments based on estimates of a given shipment's weight and the distance it is transported.

The current calculations methods are limited because they do not disaggregate the shipments, for example by disaggregating the shipments and emissions down to the individual package or individual item/product. Therefore, there is a need of a method and a system for allocating emissions resulting from transportation, which includes calculating the environmental impact (e.g., emissions) per individual package or individual product.

### BRIEF DESCRIPTION

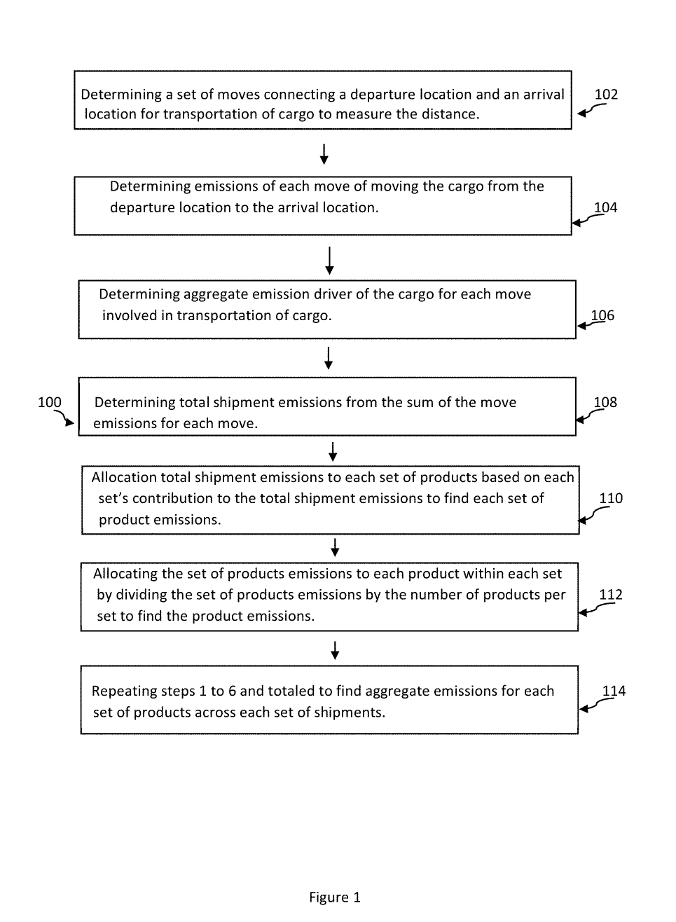

FIG. 1 illustrates a flowchart of one example of a method for allocating the emissions resulting from transporting cargo.

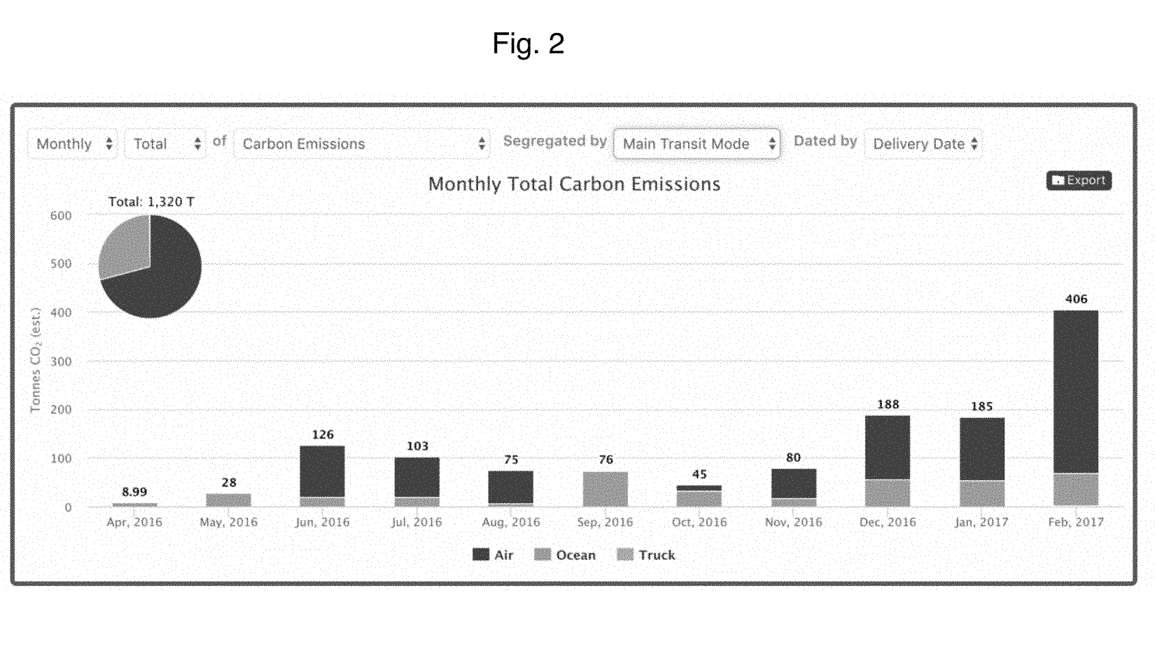

FIG. 2 illustrates a chart of emissions generated by months and attributing emissions to methods of movement.

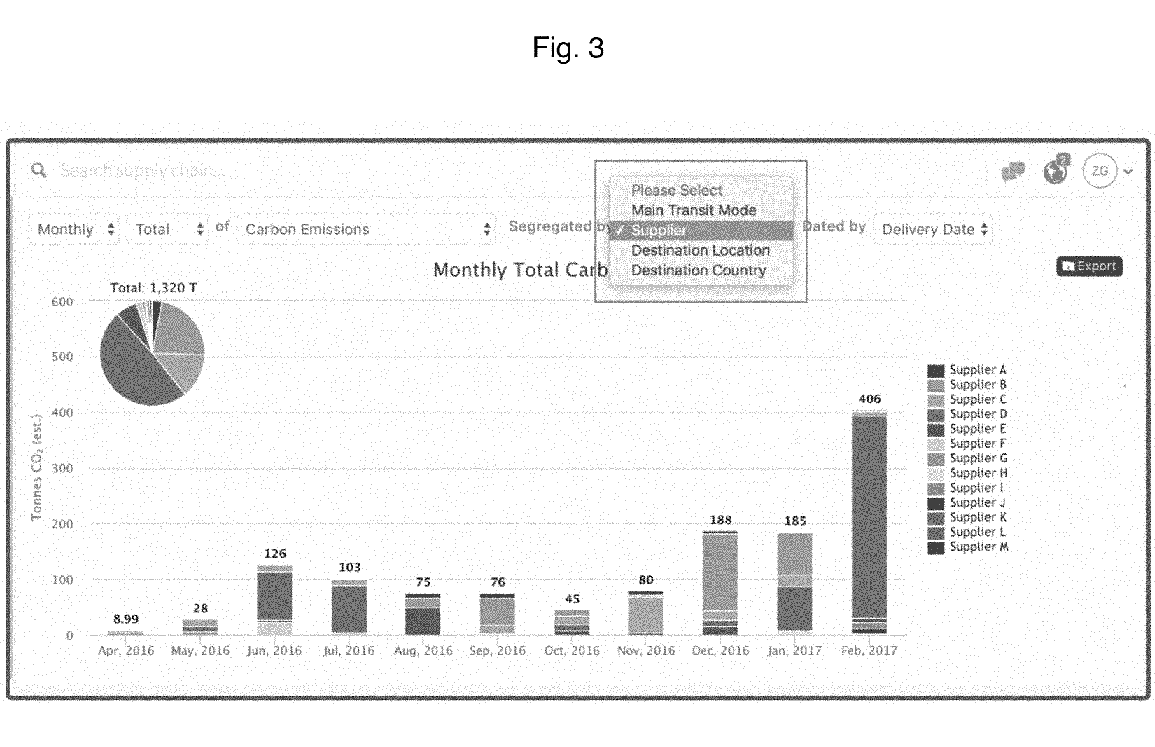

FIG. 3 illustrates a chart of how emissions may be segregated by other categories, e.g., Main Transit Mode, Supplier, Destination Location, or Destination Country.

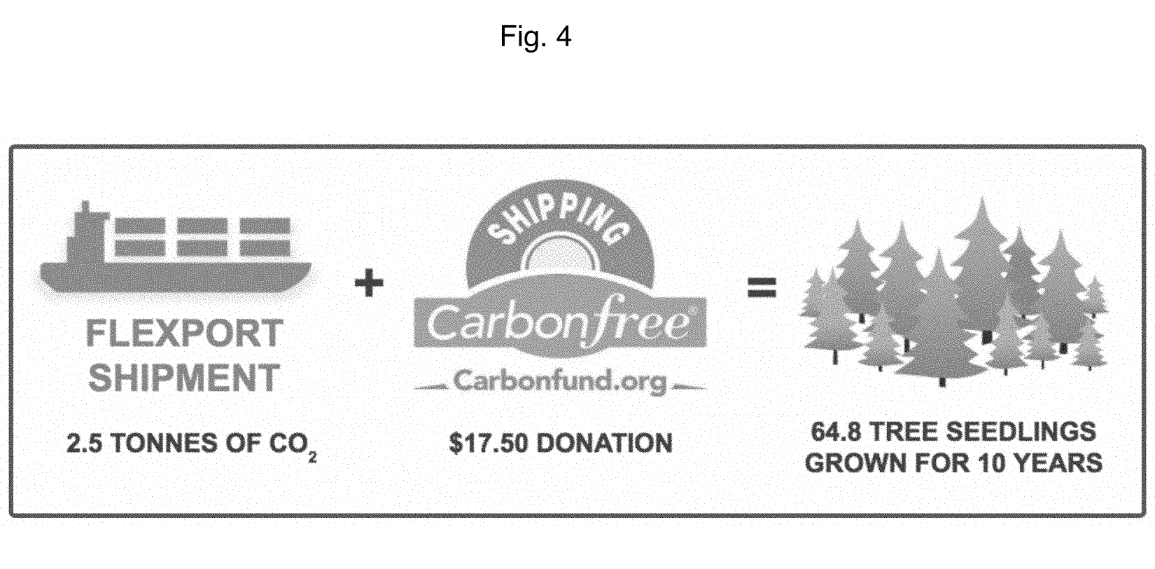

FIG. 4 illustrates an example of how carbon offsets.

### DETAILED DESCRIPTION

Disclosed herein is a method and system for allocating emissions resulting from transportation of cargo comprising disaggregating the emissions for the cargo down to the product level.

In one embodiment, the method includes the step of determining a set of moves connecting a departure location and an arrival location for transportation of cargo to measure the distance, determining emissions of each move of moving the cargo from the departure location to the arrival location; determining aggregate emission driver of the cargo for each move involved in transportation of cargo; determining total shipment emissions from the sum of move emissions for each move; allocating total shipment emissions to each set of products based on each set's contribution to the total shipment emissions to find each set of products emissions; allocating the set of products emissions to each product within each set by dividing the set of products emissions by the number of products per set to find the product emissions; and repeating the steps to find aggregate emissions for each set of products across each set of shipments.

As used herein, the term “determining a set of moves” refers to analyzing the steps needed to move mass from one location to another. In one embodiment, determining a set of moves comprises evaluating from the departure location to the arrival location. In one embodiment, determining a set of moves comprises evaluating from the arrival location to the departure location. In one embodiment, determining a set of moves comprises breaking down each method of transport for moving mass. In one embodiment, determining a set of moves comprises working backwards, e.g., backwards in time, backwards in space, etc.

As used herein, the term “location” means a physical geographic place defined by a variety of known methods, such as GPS coordinates, Cartesian coordinates, polar coordinates, latitude, longitude, etc.

As used herein, the term “departure location” means the specific geographic place occupied by a thing when the process of moving that thing begins from where it is stationary. For example, when shipping a thing from Shenzhen to Bakersfield, the “departure location” would be Shenzhen (the place from which the thing is shipped).

Within the context of this disclosure, the term “departure location” may also be referred to as an origin, arrival location, etc.

As used herein, the term “arrival location” means the specific geographic place occupied by a thing when the process of moving that thing concludes to where it becomes stationary. For example, when shipping a thing from Shenzhen to Bakersfield, the “arrival location” would be Bakersfield (the place to which the thing is shipped).

Within the context of this disclosure, the term “arrival location” may also be referred to as a destination, end location, etc.

As used herein, the term “measure the distance” refers to ascertaining the amount of physical length an item would travel. In one embodiment, the term “measure the distance” comprises movement across roads, water, air, etc. In one embodiment, the term “measure the distance” comprises inches, feet, miles, meters, kilometers, etc.

As used herein, the term “determining emissions of each move” refers to calculating the discharge or production of gas, radiation, or other byproducts, such as heat or other energy not directly utilized, associated with the movement of mass. In one embodiment, determining the emission of each move comprises calculating the amount of greenhouse gases produced. In one embodiment, determining emissions of each move comprises analyzing auxiliary factors associated with direct movement of mass, e.g., the emissions associated with making the product, the emissions associated with processing fuels, etc.

In one embodiment, determining emissions of each move comprises utilizing different calculations for each method of movement, e.g., ocean, air, truck, or rail. In one embodiment, emissions are calculating for moving mass across the ocean comprising factors chosen from a vessel's utilization rate, the number of Twenty-Foot-Equivalent-Unit (TEU), etc. In one embodiment, emissions are calculating for moving mass by truck comprising factors chosen from drayage, full truckload (FTL), less than truckload (LTL), etc. In one embodiment, emissions are calculating for moving mass through the air comprising factors chosen from chargeable weight, total distance, length of flight, etc. In one embodiment, emissions are calculating for moving mass by rail comprising factors chosen from number of stops, number of cars, etc.

FIG. 2 illustrates one example of how emissions from different methods of movement are presented using the aforementioned calculations for each different type of transportation, including providing a user with various options, e.g., using a drop down menu to view specific emissions based on method of transportation. FIG. 2 also provides the ability to export information, e.g., Excel sheet, pdf, etc.

FIG. 3 illustrates one example of how emissions are further categorized by “Main Transit Mode”, “Supplier”, “Destination Location”, and “Destination Country” within some embodiments of this disclosure. FIG. 3 illustrates how various metrics and analytics are used to allocate emissions to various sources, e.g., suppliers.

As used herein, the term “determining aggregate emission driver” refers to ascertaining all the emission driver factors. In one embodiment, determining aggregate emission driver comprises a visual medium, e.g., a screen or other display means. For example, FIGS. 2 and 3 illustrate exemplary visual representations of exemplary emission drivers.

As used herein the term “emission driver” refers to one or more factors that determines the amount of emissions produced in transporting cargo or components of cargo, such as products and/or set of products. Within the context of this disclosure, emission drivers include weight, volume, category of item, climate control requirements, and/or value. For example, a truck may be limited by the volume and weight of the shipment. In the above example of a truck, the emissions per pillow transported would be primarily a factor of the volume of pillows. By contrast, in the example of a truck, the emissions per gold bar would be more influenced by the weight of the gold.

FIG. 2 provides one illustrative example of how various emission drivers are presented on a display means. FIG. 3 provides one illustrative example of how to view various emission drivers.

As used herein, the term “determining total shipment emissions” refers to calculating the entire amount of emissions produced from the movement of mass. In one embodiment, determining total shipment emissions comprises the total amount of greenhouse gases produced. In one embodiment, the total shipment emissions comprise all emission drivers.

As used herein, the term “set of products” refers to the mass moved from one location to another location. In one embodiment, the set of products are the same type of mass. In one embodiment, the set of products are from the same place. In one embodiment, the set of products are from different places. In one embodiment, the set of products are divided into individualized categories, e.g., perishables, electronics, books, hazardous materials, etc. In one embodiment of the disclosed systems and methods, the “set of products” makes up a component of cargo, which each product in the set having the same emissions factors, for example, a container/pallet/carton/portion of carton, etc. having substantially the same items throughout. For example, a device suitable for shipping cargo, having a plurality of the same t-shirt; or the same pillow; or the same smartphone, etc.

As used herein, the term “allocating total shipment emissions” refers to attributing the gas, radiation, or other byproducts, such as heat or other energy not directly utilized, produced from the movement of mass to each set of products. In one embodiment, allocating total shipment emissions comprises distributing the total emissions to each set of products based on origin. In one embodiment, allocating total shipment emissions comprises distributing the total emissions to each set of products based on the type of product, e.g., electronics, assembled products, parts, etc. In one embodiment, allocating total shipment emissions comprises distributing the total emissions to each set of products based on distance traveled. In one embodiment, allocating total shipment emissions comprises distributing the total emissions to each set of products based on weight.

As used herein, the term “set of product emissions” refers to a collection of gas, radiation, or other byproducts, such as heat or other energy not directly utilized, produced during the movement of mass from a departure location to an arrival location associated with a set of products. In one embodiment, the set of product emissions are based on the origin of the set of products. In one embodiment, the set of product emissions is further divided into the type of emission, e.g., the amount of carbon dioxide produced.

As used herein, the term “allocating the set of product emissions” refers to attributing gas, radiation, or other byproducts, such as heat or other energy not directly utilized, produced to an individualized piece of mass. In one embodiment, allocating the set of product emissions comprises dividing the total shipment emissions by the total mass. In one embodiment, allocating the set of product emissions comprises dividing the total shipment emissions by the total number of products. In one embodiment, allocating the set of product emissions comprises displaying the emissions produced per individual product.

As used herein, the term “different shipments” refers to mass not belonging to the same movement of other mass. In one embodiment, different shipments comprise mass moving on different days. In one embodiment, different shipments comprise mass moving on path routes. In one embodiment, different shipments comprise different types of mass moving on the same route. In one embodiment, the emissions produced by individual shipments are presentable to a user.

In one embodiment, emission reports are available in various ways and/or presented via various media, e.g., on custom reports, invoices, order confirmations, etc. In one embodiment, an emission report is provided within a quote. In one embodiment, an emission report is provided along with route information. In one embodiment, the methods and systems disclosed herein comprise displaying an amount of emissions within an invoice.

In one embodiment, the methods and systems disclosed herein comprise displaying an amount of emissions next to cost. In one embodiment, the cost is represented in US dollars. In one embodiment, the cost is represented in British pounds. In one embodiment, the cost is represented in Euros. In one embodiment, the cost is represented in renminbi.

In one embodiment, the methods and systems disclosed herein comprise displaying an amount of emissions within a list of options, with the said options juxtaposing the emissions for a plurality of transportation options.

The following detailed description is directed to certain specific embodiments of the invention. However, the invention can be embodied in a multitude of different ways as defined and covered by the claims and their equivalents. Unless otherwise noted in this specification or in the claims, all of the terms used in the specification and the claims will have the meanings normally ascribed to these terms by persons of ordinary skill in the art.

FIG. 1 illustrates a flowchart of a method 100 for allocating emissions resulting from transporting cargo. Within the context of this disclosure, “transporting cargo” includes any method of transportation available in the art. Examples of modes of transportation include, but are not limited to, airplane, ship, barge, train, truck, bicycle, foot, courier, and car. Examples of emissions include, but are not limited to, CO2, sulphur compounds, hazardous compounds, nitrogen compounds, greenhouse gases, particulate matter, thermal and/or radioactive waste.

Further, within the context of this disclosure, particular embodiments of emissions may be either direct or indirect. For example, in one embodiment, calculating the emissions for an electrical vehicle would account for the coal or natural gas power plants involved in producing the electricity. Further, the emissions may be measured in absolute or relative terms, such as CO2 ton equivalents. Examples of cargo within the context of this disclosure include homogenous or heterogeneous sets of products, which may be aggregated in any device suitable for shipping the cargo, including pallet, container, cartons, etc. In each case, the device suitable for shipping the cargo may be filled with the same or different sets of products.

Within the example illustrated by FIG. 1, 100, initiates with a step 102 for determining a set of moves and the total distance connecting a departure location and an arrival location within the context of transporting cargo.

The step 102 is then followed by a step 104 for determining emissions of each move involved in moving the cargo from the departure location to the arrival location. In one embodiment, the distance calculated is from the departure location of shipment to the arrival location of shipment. For purposes of providing in-depth measurement, additional embodiments including measuring the distance from the departure location of move to the arrival location of shipment and/or measuring distance from the end location of shipment to the end location of move.

In FIG. 1, the step 104 is then followed by a step 106, which includes determining the aggregate emission driver of the cargo for each move involved in transporting the cargo. In the example shown in FIG. 1, the aggregate emission driver is a function of the transportation mode. In one example, aggregate emission driver may be based on the chargeable weight of each transport mode and the volume and weight ceiling for each medium of the transport.

In one embodiment, each move's emissions are determined from distance, emission factor, and the aggregate emission driver. In one embodiment, emission factor is based upon the type of product and the set of product. In another embodiment, the aggregate emission driver is a function of mode, where the total cargo size is known but the size of the product is not known.

The step 106 is then followed by a step 108, which includes determining total shipment emissions from the sum of move emissions for each move, where the sum provides the total of move emissions for each move. The step 108 is then followed by a step 110 for allocating total shipment emissions to each set of products based on each set's contribution to the total shipment emissions, thereby providing set of products emissions.

In one embodiment, the set of products emissions are determined via the total emission driver method.

In one illustrative example, 100 pillows and 100 smartphones are transported in a container. The pillows take up 9 cbm (cubic meter) and the smartphones take up 1 cbm. Thus, the pillows' set of products emissions are 90% [9 cbm/(9 cbm/+1 cbm)] of the total shipment emissions. Likewise, the smartphones' set of products emissions are 10% [1 cbm/(9 cbm/+1 cbm)] of the total shipment emissions.

In one embodiment, the total product value is determined with chargeable weight or volume logic.

In one illustrative example of determining total emissions for total product value, the container contains 100 pillows and 100 smartphones. In this example, the pillows' cost is USD 100 total and the smartphones' cost is USD 900 total. Accordingly, in applying the total product value to this example, the pillows' set of products emissions are 10% [$100/($900+$100)] and the smartphones' set of products emissions are 90% [$900/($900+$100)] of the total shipment emissions.

In one embodiment of the disclosure, when all product value attributes are known for a similar metric (e.g., type, cost, or price but not mixtures thereof), then the total product value may be calculated from the sum of product value.

In one embodiment, for each product, the product's percentage value in the shipment is calculated. The product's percentage value in the shipment is then product value/total product value.

In one embodiment of the disclosure, the products are known but the cbm is not known for all of the products. One illustrative example of this situation is a shipment having 100 pillows and 100 smartphones, where the 100 pillows and 100 smartphones are transported in a container. In this example, the pillows cost $100 in total and take up 9 cbm of volume; and the smartphones cost $900 total but the cbm is unknown. In this example, one embodiment of the disclosed method of allocating emissions includes first determining that the smartphones represent 90% of the total value, then multiplying the pillows' 9 cbm by the smartphones relative value (90%/10%) to get 81 cbm for the smartphones. Then, the percentage of total cbm would be 10% for the pillows and 90% for the smartphones.

For illustrative purposes, various metrics, analytics, and comparisons are provided within a physical tangible representation, such as a user interface or a quote or an invoice. For example, one comparison illustrates how 5 tonnes (metric ton) of CO2 emissions is equivalent to 563 gallons of gasoline consumed. One comparison illustrates how 5 tonnes of CO2 emissions is also equivalent to 3 round trips between Los Angeles, Calif. and New York City by road in a 2017 Volkswagen Beetle. One comparison illustrates how 5 tonnes (metric ton) of CO2 emissions is also equivalent to 5,335 pounds of burned coal. One comparison illustrates how 5 tonnes (metric ton) of CO2 emissions is also equivalent to an average home's energy use in 6 months. One comparison illustrates how 5 tonnes (metric ton) of CO2 emissions is equivalent to 11.6 barrels of oil consumed.

It would be readily apparent to those skilled in the art that various methods may be envisioned to calculate the percentage emission factor of a total for set of homogenous or heterogeneous products based on an underlying emission driver, without deviating from the scope of the present disclosure.

The step 110 is then followed by a step 112 for allocating the set of products emissions to each product within each set by dividing the set of products emissions by the number of products per set to find the product emissions. In an example where a set of products consists of 100 pillows, then the emissions for each individual pillow could be calculated as follows: 1/100×set of products emissions.

In some embodiments, the step 112 is then followed by a step 114 of repeating the steps 1 to 6 and totaled to find aggregate emissions for each set of products across each set of shipments. For exemplary purposes, a set oft-shirts that followed the same exact route over 3 separate shipments, where ⅓ were in a container of just t-shirts, would have an aggregate total reflecting the average product emissions multiplied by the total number oft-shirt transported. In some embodiments, the step 112 is omitted.

In one embodiment, the methods and systems disclosed herein are used in conjunction with an emission offset program. In one embodiment, carbon credits are offered, for example as part of a payment, quoting, or invoicing system. In one embodiment, a carbon credit is equivalent to one tonne of emissions. In one embodiment, a carbon credit is used to offset one tonne of emissions already produced. In one embodiment, a certificate of documentation is provided to a user who elects to exchange carbon credits during a transaction.

FIG. 4 is an illustrative example of equating emissions with dollars within a display means as part of the disclosure for mass moving from China to the United States West Coast generates emissions and how participation in an offset program would alleviate emissions.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

What is claimed is:

1. A method for allocating emissions resulting from transportation of cargo comprising:
determining a set of moves connecting a departure location and an arrival location for transportation of cargo to measure the distance;
determining emissions of each move of moving the cargo from the departure location to the arrival location;
determining aggregate emission driver of the cargo for each move involved in transportation of cargo;
determining total shipment emissions from the sum of move emissions for each move;
allocating total shipment emissions to each set of products based on each set's contribution to the total shipment emissions to find each set of products emissions; and
allocating the set of products emissions to each product within each set by dividing the set of products emissions by the number of products per set to find the product emissions.

2. The method of claim 1, comprising:
repeating the steps for two or more different shipments; and
determining aggregate emission driver for each set of products across each set of shipments.

3. The method of claim 1, comprising displaying an amount of emissions within an invoice.

4. The method of claim 1, comprising displaying an amount of emissions next to a cost.

5. The method of claim 1, comprising displaying an amount of emissions within a list of options.
